(19) United States
(12) Patent Application Publication
(10) Pub. No.: US 2026/0230965 A1
(43) Pub. Date: Aug. 6, 2026

(54) FAST SETUP/RESUME

(71) Applicant: InterDigital Patent Holdings, Inc., Wilmington, DE (US)

(72) Inventors: Brian Martin, Farnham (GB); Oumer Teyeb, Montreal (CA); Martino Freda, Laval (CA); Paul Marinier, Brossard (CA); Dylan Watts, Montreal (CA); Keiichi Kubota, Setagaya-Ku (JP); Erdem Bala, East Meadow, NY (US)

(73) Assignee: InterDigital Patent Holdings, Inc., Wilmington, DE (US)

(21) Appl. No.: 19/149,934

(22) PCT Filed: Feb. 10, 2024
(86) PCT No.: PCT/US2024/015293

§ 371 Date: Jul. 22, 2025

Related U.S. Application Data
(60) Provisional application No. 63/445,557, filed on Feb. 14, 2023.

(51) Int. Cl. H04W 36/04; H04B 17/318; H04W 36/00; H04W 76/20; H04W 76/30; H04W 80/02

(52) U.S. Cl. CPC H04W 36/04; H04B 17/328; H04W 36/0058; H04W 76/20; H04W 76/30; H04W 80/02

(57) ABSTRACT

A wireless transmit/receive unit (WTRU) may be configured for L1/L2-triggered mobility (LTM). A WTRU may receive configuration information from a cell while the WTRU is in a connected mode. The configuration information may indicate a plurality of LTM candidate cells. The WTRU may receive a measurement configuration while the WTRU is in an inactive mode. The WTRU may perform measurements on one or more of the plurality of LTM candidate cells while the WTRU is in the inactive mode in accordance with the measurement configuration. The WTRU may send a report comprising these measurements during a random access procedure. The WTRU may receive candidate configuration information for at least one LTM candidate cell of the plurality of LTM candidate cells during the random access procedure. The WTRU may execute an LTM procedure for the at least one LTM candidate cell upon transition to the connected mode.

### CROSS-REFERENCE TO RELATED APPLICATIONS

This application claims the benefit of U.S. Provisional Patent Application No. 63/445,557, filed on Feb. 14, 2023, the entire contents of which are incorporated herein by reference.

### BACKGROUND

This disclosure pertains to devices, methods, and systems for fast Secondary Cell (SCell) and Secondary Cell Group (SCG) setup and resume.

### SUMMARY

Devices, methods, and systems for enabling fast Secondary Cell (SCell) and Secondary Cell Group (SCG) setup and resume are discussed herein. A wireless transmit/receive unit (WTRU) may be configured for Layer 1 (L1) and Layer 2 (L2) based inter-cell mobility, measurements, and RRC_INACTIVE. In some implementations the WTRU may be configured for fast setup/resume (e.g., early measurements and a L1/L2 Triggered Mobility (LTM) trigger during random access procedure). The WTRU may be configured for updating an LTM candidate in RRC_INACTIVE. The WTRU may be configured for maintaining LTM early measurement in RRC_INACTIVE.

Devices, methods, and systems for fast SCG and SCell setup and resume based on early measurements and/or an LTM trigger during a random access (RA) procedure are discussed herein. In some implementations, the WTRU may receive pre-configuration of LTM candidate cells (e.g., configuration information) in RRC_CONNECTED. The WTRU may receive a measurement configuration in RRC Release. The WTRU may perform the measurements in RRC_INACTIVE. The WTRU may report the measurements related to the LTM candidate cells during the random access procedure. For example, the WTRU may report the measurements related to the LTM candidate cells during the random access procedure (e.g., in a Medium Access Control (MAC) Control Element (CE) with Msg3 (4 step RA) or Msg A (for 2 step RA)). The WTRU may optionally perform early synchronization to a set of best candidate cells. In some implementations, the WTRU may receive an indication of candidate configuration and SCell activation and/or deactivation during the random access procedure (e.g., candidate configuration information). For example, the WTRU may receive the indication of candidate configuration and SCell activation or deactivation during the random access procedure (e.g., in MAC CE with Msg4 (4 step RA) or MsgB (2 step RA)). In some implementations, the WTRU may execute an LTM procedure upon transition to RRC_CONNECTED. For example, the WTRU may apply stored LTM Primary Cell (PCell) configuration, with immediate SCell/SCG activation upon entering RRC_CONNECTED.

In some examples, a WTRU may receive configuration information from a cell while the WTRU is in a connected mode. The configuration information may indicate a plurality of LTM candidate cells. The WTRU may receive a measurement configuration while the WTRU is in an inactive mode. The WTRU may perform measurements on one or more of the plurality of LTM candidate cells while the WTRU is in the inactive mode in accordance with the measurement configuration. The WTRU may send a report comprising these measurements during a random access procedure. The WTRU may receive candidate configuration information for at least one LTM candidate cell of the plurality of LTM candidate cells during the random access procedure. The WTRU may execute an LTM procedure for the at least one LTM candidate cell upon transition to the connected mode.

In some examples, the WTRU may receive the measurement configuration via a radio resource control (RRC) release message while the WTRU is in the inactive mode. The WTRU may receive the candidate configuration information via a medium access control (MAC) control element (CE). The WTRU may perform early synchronization to the at least one LTM candidate cell prior to receiving the candidate configuration information. The WTRU may apply the candidate configuration information for the at least one LTM candidate cell to execute the LTM procedure upon entering the connected mode.

In some examples, the measurements the WTRU performs on one or more of the plurality of LTM candidate cells may comprise reference signal received power (RSRP) measurements. The WTRU may send the report comprising the measurements related to the LTM candidate cells via a MAC CE.

In some examples, the configuration information may comprise parameters. The WTRU may select one or more LTM candidate cells based on the parameters. Further, the WTRU may include an indication in a report (e.g., the same report which comprises the measurements of one or more of the plurality of LTM candidates) of one or more selected LTM candidate cells. The parameters may comprise an RSRP threshold, and/or a reference signal received quality (RSRQ) threshold.

### BRIEF DESCRIPTION OF THE DRAWINGS

A more detailed understanding may be had from the following description, given by way of example in conjunction with the accompanying drawings, in which like reference numerals in the figures indicate like elements.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A.

FIG. 1C is a system diagram illustrating an example radio access network (RAN) and an example core network (CN) that may be used within the communications system illustrated in FIG. 1A.

FIG. 1D is a system diagram illustrating a further example RAN and a further example CN that may be used within the communications system illustrated in FIG. 1A.

FIG. 2 illustrates an example high-level measurement model.

FIG. 3 illustrates example Radio Resource Control (RRC) states and the transitions between the RRC states.

FIG. 4 illustrates an example Layers 1 and 2 Triggered Mobility (LTM) using Carrier Aggregation (CA).

FIG. 5 illustrates an example LTM baseline procedure.

FIG. 6 illustrates examples of using early measurements for a quick setup of CA and Dual Connectivity (DC) when a WTRU switches from an inactive mode (e.g., RRC_INACTIVE) to a connected mode (e.g., RRC_CONNECTED).

FIG. 7 illustrates an example procedure and signaling for fast setup and/or resume.

FIG. 8 illustrates an example procedure for fast setup and/or resume.

FIG. 9 illustrates an example procedure and signaling for LTM candidate maintenance in RRC_INACTIVE.

FIG. 10 illustrates an example procedure for LTM candidate maintenance in RRC_INACTIVE.

FIG. 11 illustrates an example procedure and signaling for LTM early measurement maintenance in RRC_INACTIVE.

FIG. 12 illustrates an example procedure for LTM early measurement maintenance in RRC_INACTIVE.

### DETAILED DESCRIPTION

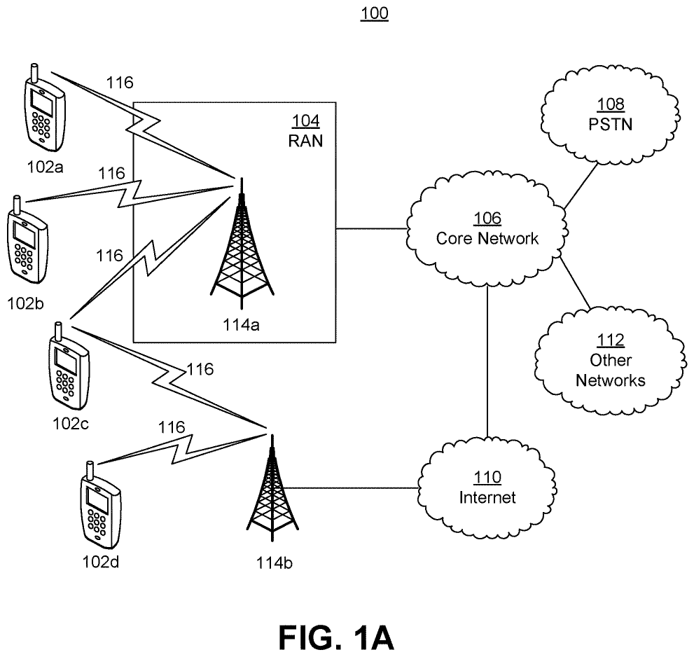

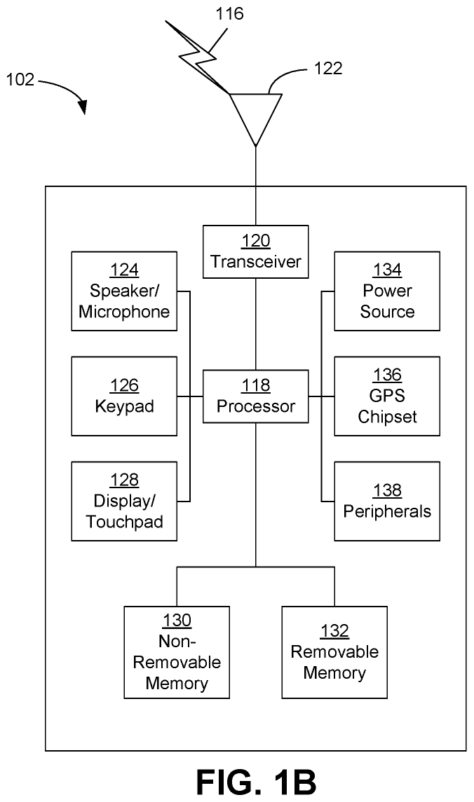

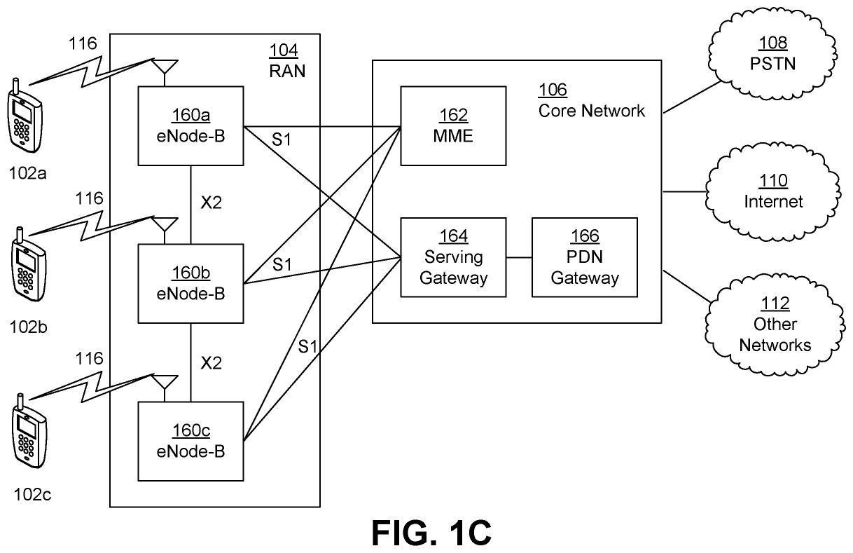

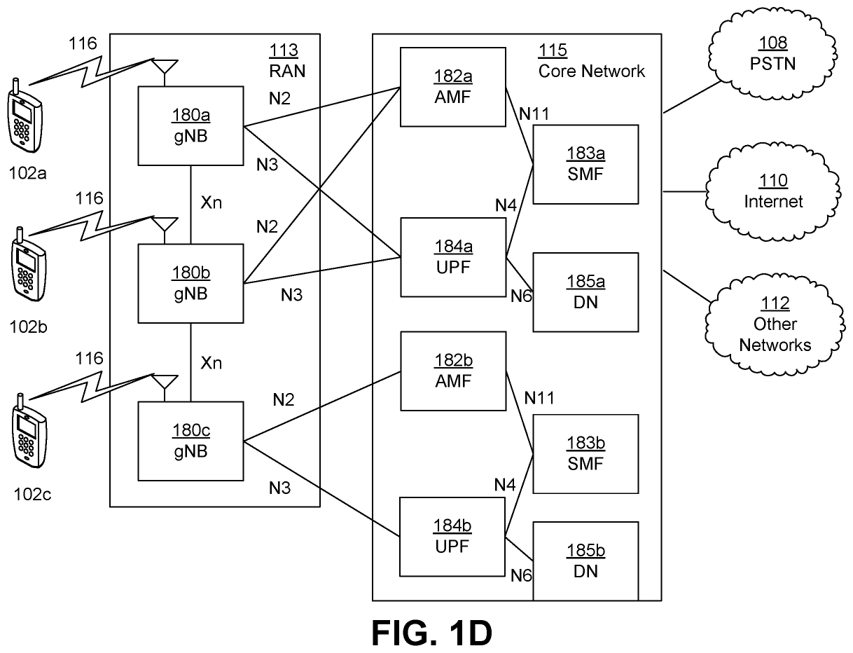

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114 b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, in which the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUS 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms, among others, are used herein: Acknowledgement (ACK); Block Error Rate (BLER); Bandwidth Part (BWP); Carrier Aggregation (CA); Channel Access Priority (CAP); Channel access priority class (CAPC); Component Carrier (CC); Clear Channel Assessment (CCA); Control Channel Element (CCE); Control Element (CE); Configured Grant or Cell Group (CG); Conditional Handover (CHO); Cyclic Prefix (CP); Conventional OFDM (relying on cyclic prefix) (CP-OFDM); Conditional PsCell addition (CPA); Conditional PsCell addition/change (CPAC); Conditional PsCell change (CPC); Channel Quality Indicator (CQI); Cyclic Redundancy Check (CRC); Channel State Information (CSI); Centralized Unit (CU); Contention Window (CW); Contention Window Size (CWS); Channel Occupancy (CO); Downlink Assignment Index (DAI); Dual Connectivity (DC); Downlink Control Information (DCI); Downlink feedback information (DFI); Dynamic grant (DG); Downlink (DL); Demodulation Reference Signal (DM-RS); Data Radio Bearer (DRB); enhanced Licensed Assisted Access (eLAA); Further enhanced Licensed Assisted Access (FeLAA); Hybrid Automatic Repeat Request (HARQ); License Assisted Access (LAA); Listen Before Talk (LBT); Long Term Evolution (e.g., from 3GPP LTE Release 8 and up) (LTE); Layers 1 and 2 triggered mobility (LTM); Layer 1 (L1); Layer 2 (L2); Negative ACK (NACK); Master cell group (MCG); Medium Access Control (MAC); Modulation and Coding Scheme (MCS); Multiple Input Multiple Output (MIMO); New Radio (NR); Orthogonal Frequency-Division Multiplexing (OFDM); Primary cell (PCell); Physical cell identity (PCI); Physical Layer (PHY); Process ID (PID); Paging Occasion (PO); Physical Random Access Channel (PRACH); Primary SCG Cell (PSCell); Primary Synchronization Signal (PSS); Random Access (or procedure) (RA); Random Access Channel (RACH); Random Access Response (RAR); Radio access network Central Unit (RCU); Radio Front end (RF); Radio Link Control (RLC); Radio Link Failure (RLF); Radio Link Monitoring (RLM); Radio Network Identifier (RNTI); RACH occasion (RO); Radio Resource Control (RRC); Radio Resource Management (RRM); Reference Signal (RS); Reference Signal Received Power (RSRP); Received Signal Strength Indicator (RSSI); Secondary Cell (SCell); Secondary cell group (SCG); Service Data Unit (SDU); Special Cell (SpCell); Sounding Reference Signal (SRS); Synchronization Signal (SS); Secondary Synchronization Signal (SSS); Switching Gap (in a self-contained subframe) (SWG); Semi-persistent scheduling (SPS); Supplemental Uplink (SUL); Transport Block (TB); Transport Block Size (TBS); Transmission-Reception Point (TRP); Time-sensitive communications (TSC); Time-sensitive networking (TSN); Uplink (UL); Ultra-Reliable and Low Latency Communications (URLLC); Wide Bandwidth Part (WBWP); Wireless Local Area Networks and related technologies (IEEE 802.xx domain) (WLAN). SpCell may refer to either the PCell of the MCG or the PSCell of the SCG depending on whether the MAC entity is associated with the MCG or the SCG.

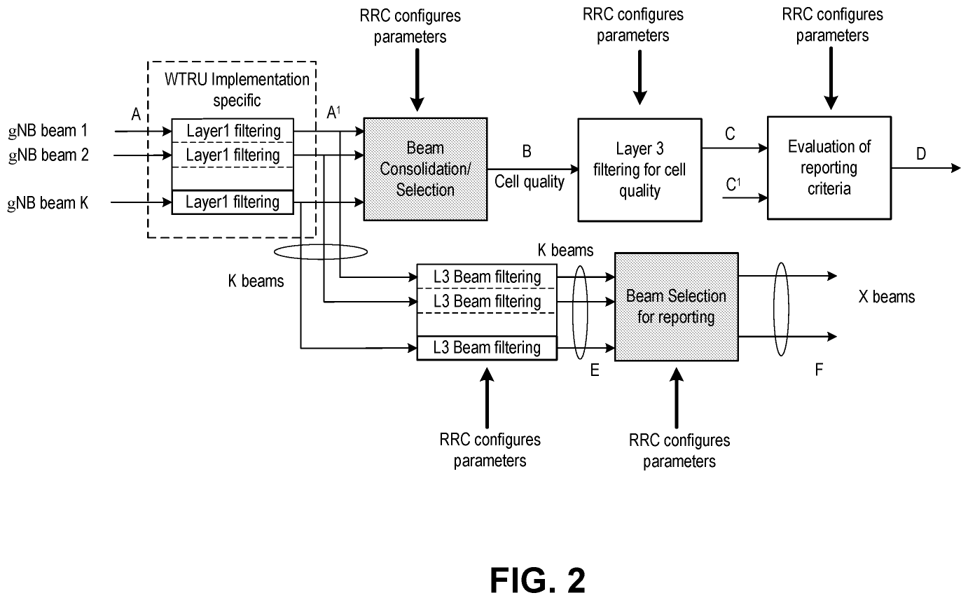

In RRC_CONNECTED, the WTRU may measure one or more beams of a cell. The WTRU may average the measurements results (e.g., power values) to derive the cell quality. In some cases, the WTRU may be configured to consider a subset of the detected beams. The WTRU may filter at two different levels: at the physical layer to derive beam quality and at RRC level to derive cell quality from multiple beams. Cell quality from beam measurements may be derived in the same way for the serving cell(s) and for the non-serving cell(s). Measurement reports may contain the measurement results of one or more beams (e.g., the X best beams) if the WTRU is configured to do so by the gNB. FIG. 2 shows an example of the corresponding high-level measurement model.

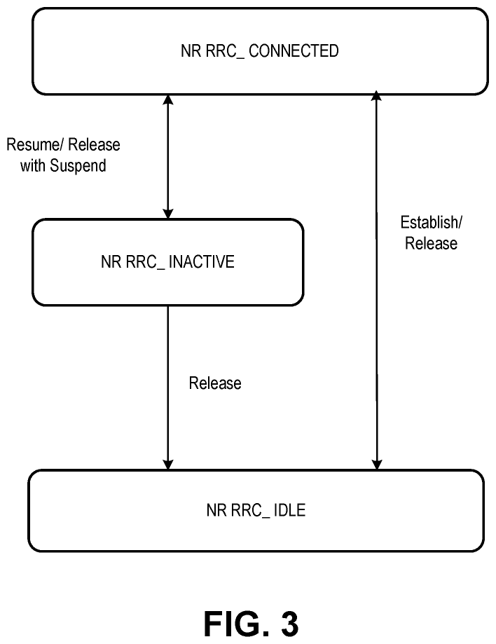

In some cases, the WTRU may be configured for RRC Connection states and state transitions. In NR, the WTRU may be configured in one of the following three RRC states: RRC_CONNECTED; RRC_INACTIVE; and RRC_IDLE. RRC_CONNECTED may also be referred to as “CONNECTED mode”. RRC_INACTIVE may also be referred to as “INACTIVE mode” in this document. RRC_IDLE may also be referred to as “IDLE mode”. FIG. 3 illustrates an example of the different RRC states and the transitions between them.

In some cases, the WTRU may be configured for inter-cell L1/2 triggered mobility (LTM). The WTRU may use inter-cell beam management that may manage the beams in CA. The WTRU may use mechanisms and procedures associated with L1/L2 based inter-cell mobility for mobility latency reduction. Mechanisms and procedures of L1/L2 based inter-cell mobility for mobility latency reduction configuration and maintenance for multiple candidate cells may allow fast application of configurations for candidate cells. Further, mechanisms and procedures of L1/L2 based inter-cell mobility for mobility latency reduction may determine a dynamic switch mechanism among candidate serving cells, including SpCells and SCells (e.g., for the potential applicable scenarios based on L1/L2 signaling). Further, mechanisms and procedures of L1/L2 based inter-cell mobility for mobility latency reduction may provide L1 enhancements for inter-cell beam management, including L1 measurement and reporting, and beam indication. Further, mechanisms and procedures of L1/L2 based inter-cell mobility for mobility latency reduction may provide timing Advance management. Further, mechanisms and procedures of L 1/L2 based inter-cell mobility for mobility latency reduction may provide CU-DU interface signaling to support L1/L2 mobility, if needed. Frequency Range 2 (FR2) specific enhancements are not precluded. Further, In some cases, the procedure of L1/L2 based inter-cell mobility may be applicable to one or more of the following scenarios: a standalone, CA and NR-DC case with a serving cell change within one CG; an Intra-DU case and intra-CU inter-DU case (e.g., cases applicable for Standalone and CA and no new RAN interfaces are expected); both intra-frequency and inter-frequency; both Frequency Range 1 (FR1) and FR2; source and target cells that are synchronized or non-synchronized; and/or an inter-CU case is not included.

L1/L2 based mobility and inter-cell beam management may address intra-DU and intra-frequency scenarios. In such cases, the serving cell may remain unchanged (e.g., there is no possibility to change the serving cell using L1/2 based mobility). In FR2 deployments, CA may be used to exploit the available bandwidth to aggregate multiple CCs in one band. These CCs may be transmitted with the same analog beam pair (e.g., a gNB beam and WTRU beam). The WTRU may be configured with TCI states for reception of PDCCH and PDSCH. The TCI states may be fairly large number (e.g., 64). Each TCI state may include a RS or SSB that the WTRU refers to set its beam. The SSB may be associated with a non-serving PCI. MAC signaling (e.g., a “TCI state indication for WTRU-specific PDCCH MAC CE”) may activate the TCI state for a Coreset and/or PDCCH. Reception of PDCCH from a non-serving cell may be supported by MAC CE indicating a TCI state associated to non-serving PCI. MAC signaling (e.g., a “TCI States Activation/Deactivation for WTRU-specific PDSCH”) may activate a subset of (up to) 8 TCI states for PDSCH reception. DCI may indicate the 8 TCI states. A WTRU may also support “unified TCI state” with a different updating mechanism (e.g., DCI-based), but without multi-TRP. A WTRU may support unified TCI state with multi-TRP.

A WTRU may use LTM to improve handover latency. With a conventional L3 handover or conditional configuration, the WTRU may first send a measurement report using RRC signaling. In response to sending the measurement, the network may provide a further measurement configuration and potentially a conditional handover configuration. With a conventional handover, the network provides a configuration for a target cell after the WTRU reports, using RRC signaling, that the cell meets configured radio quality criteria. With a conditional handover, the network provides a target cell configuration as well as a measurement criteria which determines when the WTRU should trigger the CHO configuration in advance, in order to reduce the handover failure rate due to the delay in sending a measurement report, receiving an RRC reconfiguration from. Both of these L3 methods may suffer from some amount of delay associated with sending the measurement reports and receiving of the target configurations, particularly in case of the conventional (non-conditional) handover. LTM may allow a fast application of configurations for candidate cells by dynamically switching between SCells and switching of the PCell (e.g., switching the roles between SCell and PCell) without performing RRC signaling. The inter-CU case may not be included, as this requires relocation of the PDCP anchor. As such, an RRC-based approach may be needed to support inter-CU handover.

With legacy L3 handover mechanisms, any currently active SCell(s) may be released before the WTRU completes the handover to a target cell in the coverage area of a new site. The active SCell(s) may only be added back after successful handover, which leads to throughput degradation during handover. As such, one of the aims of L1/2 is to enable a CA operation to be enabled instantaneously upon serving cell change.

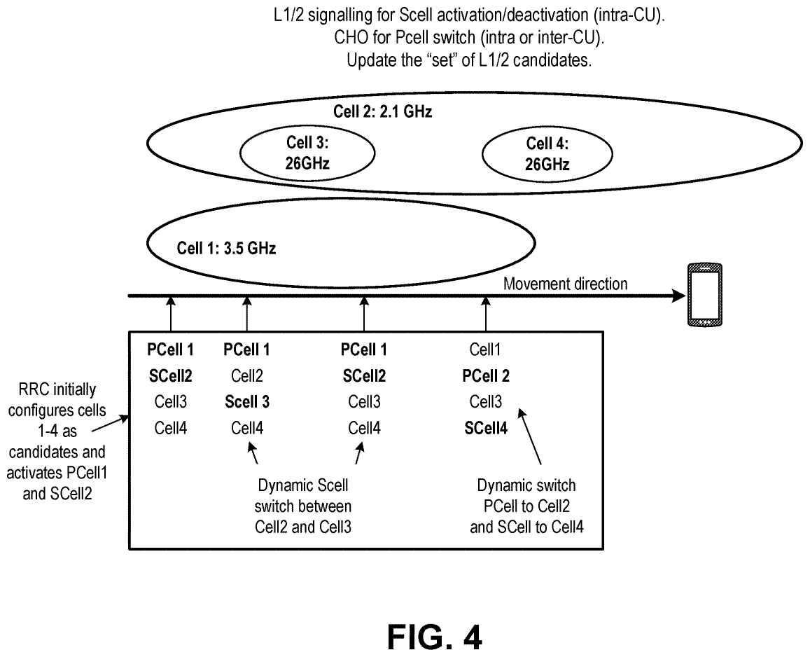

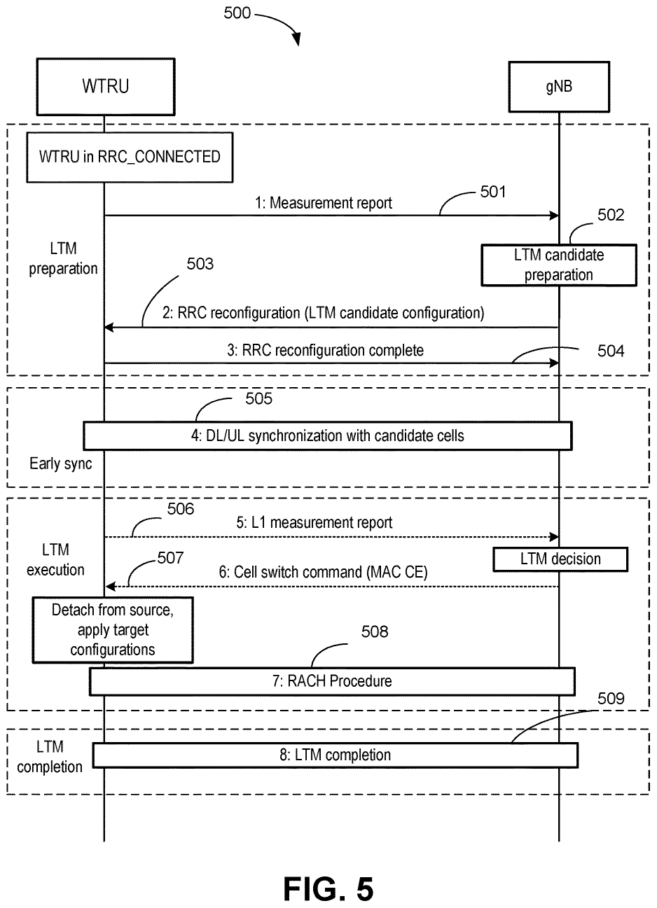

FIG. 4 illustrates an example of LTM operation. In FIG. 4, the candidate cell group is configured by RRC and a dynamic switch of PCell and SCell is achieved using L1/2 signaling. FIG. 5 illustrates an example LTM baseline procedure 500. The WTRU sends a MeasurementReport message to the gNB at 501. The gNB decides to use LTM and initiates LTM candidate preparation at 502. The gNB transmits an RRCReconfiguration message to the WTRU including the configuration of one or multiple LTM candidate target cells at 503. The WTRU stores the configuration of LTM candidate target cell(s) and transmits a RRCReconfigurationComplete message to the gNB at 504. The WTRU may perform DL synchronization and TA acquisition with candidate target cell(s) before receiving the LTM cell switch command at 505. In some cases, the WTRU may be configured to support DL synchronization for candidate cell(s) before cell switch command based on SSB. In some cases, the WTRU may be configured to support TA acquisition of candidate cell(s) before LTM cell switch command based on PDCCH ordered RACH. The PDCCH order may be triggered by source cell. At 506, the WTRU may perform L1 measurements on the configured LTM candidate target cell(s) and transmit lower-layer measurement reports to the gNB. In some cases, the WTRU may be configured to carry the lower-layer measurement reports on L1 or MAC. At 507, the gNB may decide to execute LTM cell switch to a target cell and transmit a MAC CE triggering LTM cell switch. The gNB may transmit the MAC CE triggering LTM cell switch by including the candidate configuration index of the target cell. The WTRU switches to the configuration of the LTM candidate target cell. The WTRU may receive a beam indication. At 508, the WTRU may perform random access procedure towards the target cell, if TA is not available. At 509, the WTRU may indicate successful completion of the LTM cell switch towards target cell. An uplink signal or message after the WTRU has switched to the target cell may be used to indicate successful completion of the LTM cell switch.

In some cases, the WTRU may be configured for NR early measurement. The network may configure the WTRU with Carrier Aggregation (CA) or/and Dual Connectivity (DC) to increase the data rate per user (and in some cases, increase reliability as well). In CA, the WTRU may simultaneously send or receive data to or from multiple cells of a given gNB that are operating at different carrier frequencies. In DC, on the other hand, the WTRU may be connected to two serving gNBs, known as the master node (MN) and the secondary node (SN). When operating in DC, the WTRU may be further configured in CA within the MN and/or SN. The set of cells under the MN that are configured for the WTRU are known as Master Cell Group (MCG), and the ones under the SN are referred to as Secondary Cell Group (SCG). The primary cell in the MCG is referred to as PCell, and the primary cell in the SCG is known as PSCell. The term SPCell (special Cell) is used to refer to either the PCell or the PSCell. The cells other than the SPCells are known as SCells (Secondary Cells).

The network may decide to setup CA and/or DC for the WTRU based on measurement reports received from the WTRU regarding neighbouring cells. It is noted that there is nothing preventing the network from configuring CA or/and DC blindly (e.g., without receiving a measurement report).

Early measurement reporting may be used to enable the quick setup of CA and/or DC as soon as the WTRU transitions into RRC_CONNECTED (e.g., IDLE/INACTIVE measurements). The WTRU may be configured to perform measurements on neighbouring cells while the WTRU is in RRC_INACTIVE or RRC_IDLE. The measurements may be performed on intra-frequency, inter-frequency, or/and inter-RAT neighbour cells. When the WTRU transitions to RRC_CONNECTED state, the WTRU may send the measurements, letting the network know if there are candidate neighbour cells that can be configured in CA or DC mode for the WTRU.

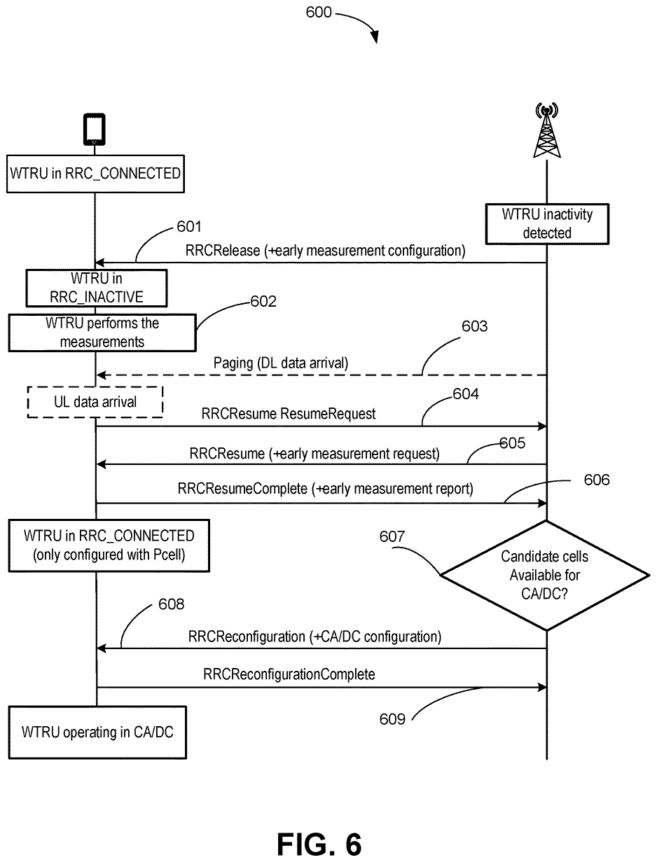

FIG. 6 illustrates an example of a procedure 600 for using early measurements for a quick setup of CA/DC when the WTRU switches to RRC_CONNECTED from RRC_INACTIVE at 600. The WTRU is provided with an early measurement configuration upon transitioning to RRC_INACTIVE at 601. The WTRU performs the measurements while the WTRU is in RRC_INACTIVE at 602. When the WTRU transitions to RRC_CONNECTED mode (e.g., when the WTRU received a paging due to DL data arrival 603 or UL data needs to be sent, etc.), the WTRU triggers the RRC Resume procedure by sending the RRC Resume Request message at 604. The network may request the WTRU to send the measurements performed during RRC_INACTIVE mode in the RRC Resume message 605, which the WTRU provides in the RRC Resume Complete message 606. Based on the RRC Resume Complete message 606, the network may immediately configure CA/DC at 607, if such candidate cells are available. The network may send an RRCReconfiguration message including CA/DC configuration at 608, and the WTRU may respond with an RRCReconfigurationComplete message at 609 and begin operating in CA/DC. Without early measurements the setup of CA/DC may have been considerably delayed as the WTRU would have to be configured with measurements to perform after the transition to RRC_CONNECTED, and the network would need to wait until the WTRU has performed these measurements and sent the measurement report before configuring CA/DC.

The IDLE/INACTIVE measurement configuration may be provided to the WTRU via dedicated message (e.g., in measIdleConfig information element (IE) in the RRCRelease message when the WTRU is transitioned to IDLE/INACTIVE). Additionally, or alternatively, the WTRU may get the IDLE/INACTIVE measurement configuration from SIB 11 (e.g., in measIdleConfig-SIB IE).

The measldle Config IE may include one or more of the following: a list of NR carrier frequencies to be measured; a list of Evolved Universal mobile telecommunications system Terrestrial Access EUTRA (e.g., LTE) frequencies; an idle measurement duration; and/or a validity area.

The list of NR carrier frequencies may be measured for CA and/or DC candidate NR cells. In some cases, the list of NR carrier frequencies may include additional information including but not limited to one or more of the following: the list of cells to be measured, the quality to be measured (e.g., RSRP or RSRQ), RSRP/RSRQ thresholds indicating which cells are to be included in the measurement report, details of SSB and beam configurations, etc.

The list of EUTRA (e.g., LTE) frequencies may correspond to inter-RAT candidate cells for DC with NR (e.g., EN-DC, NE-DC). The list of EUTRA frequencies may include additional information including but not limited to one or more of the following: the list of cells to be measured, the quality to be measured (e.g., RSRP and/or RSRQ), RSRP/RSRQ thresholds indicating which cells are to be included in the measurement report, etc.

In some examples, the idle measurement duration may be a value ranging from 10 seconds to 300 seconds. The idle measurement may specify how long the WTRU performs the measurements while in IDLE/INACTIVE.

The validity area may specify a list of frequencies (e.g., and optionally cells within that frequency). The WTRU may stop the measurements if the WTRU reselects to a cell that is not included in this validity area. In some cases, the validity area is optional. In such cases, the WTRU may be configured with one or both of a list of NR and/or a list of EUTRA frequencies.

For FR2, IDLE/INACTIVE mode measurement results reported during and/or after RRC connection setup or resume may be reused in order to improve SCell and/or SCG setup delay. New measurement requirements for FR2 may be determined such that measurements are taken more quickly, and are more “fresh” when reported, in order to account for FR2 the radio conditions that are likely to change quickly due to shorter range and smaller coverage of cells. In addition, a signaling mechanism may be introduced such that the measurements can be reported earlier. L1/2 triggered mobility (LTM) may be used to reduce mobility latency. In some cases, the WTRU may be configured to utilize early measurements and LTM features together to improve the setup time when transitioning to RRC_CONNECTED from RRC_INACTIVE.

The term “early measurements” may refer to radio quality measurements that the WTRU is configured to perform while in RRC_IDLE or RRC_INACTIVE, and report during or after RRC connection Setup or Resume.

The terms “perform LTM” or “perform LTM procedures” may refer to performing one or more (e.g., all) of the steps described in FIG. 5. In particular, “perform LTM” or “perform LTM procedures” may refer to performing early synchronization in DL and/or UL to one or more of the candidate cells, performing L1 measurements and reporting on one or more of the candidate cells, and switching (e.g., performing a handover) between candidate cells. Further, “perform LTM” may refer to the WTRU moving or switching between multiple candidate cells during the procedure.

The one or more candidate cell sets may be groups of one or more RRC configurations corresponding to a handover configuration for one or more candidate SpCells and optionally SCells. The RRC configurations may be modelled or received as one or more complete RRC Reconfiguration messages, one or more cell group configurations, and/or one or more cell configurations. Each of the candidate cell configurations (e.g., candidate configuration information) may include a candidate configuration identifier. Each of the candidate cell groups may include a candidate cell group identifier. If the grouping is performed at RRC, the switching between different sets of candidate cells may include updating the serving cell indexes and/or candidate configuration indexes. The serving cell indexes, or candidate configuration indexes may be used in L1. MAC signaling may be used to refer to specific indexes. For example, a MAC CE triggering the reconfiguration may include a candidate configuration index informing the WTRU to perform the reconfiguration on a particular cell.

The one or more candidate cell groups may be configured as a single list or group of candidate cell configurations at RRC. The grouping may occur at the early sync or LTM execution phase rather than the configuration phase. As such, the candidate cell set may be considered as a single group in terms of an RRC configuration list or group. Further, the cells selected for performing early sync, L1 measurements, and LTM execution may depend on a further grouping into multiple subsets of the overall candidate cell list. That is, the grouping itself may not be modelled at RRC using candidate configuration identifiers. However, the grouping may be executed as part of the early sync or the LTM execution procedure.

As provided herein, an LTM candidate configuration may apply to any type of preconfigured cell information. For example, the WTRU may be configured with one or more conditional reconfigurations including but not limited to, a conditional handover (CHO), conditional PSCell addition (CPA) and/or conditional PSCell change (CPC). Each such conditional reconfiguration may be valid before and/or after a cell change, or valid in certain cells.

With the introduction of LTM, the WTRU may perform inter-cell mobility procedures with a much lower latency. Pre-configured RRC reconfigurations to new cells may be triggered by MAC CE based on L1 measurement reporting, and may be controlled by DU instead of the CU. In RRC_CONNECTED, the WTRU configured with LTM may maintain the configuration for multiple SpCells and SCells even though the SpCells and SCells are not currently active.

A WTRU transitioning to RRC_INACTIVE to save power may release conditional reconfigurations (e.g., CHO, CPAC) configurations. The transition to RRC_INACTIVE may require an RRC procedure to return to RRC_CONNECTED and/or an RRC procedure to (re)setup candidates. LTM candidates may also be released upon transition to RRC_INACTIVE. However, in some embodiments, overhead and latency may be reduced by enabling the storing of multiple candidate cells in RRC_INACTIVE state to be applied upon reconfiguration (handover) triggered by lower layers (e.g., MAC CE).

In addition, the early measurement enhancements for FR2 to support faster SCG and SCell setup may likely introduce new, more challenging measurement requirements in RRC_IDLE and RRC_INACTIVE. As such, the WTRU processing requirements, and therefore power consumption, may be increased. Additionally, in FR2, the cell coverage is smaller than, for example, in FR1. As a result, the WTRU may be configured with a relatively high number of neighbor cells for measurements which, along with the more challenging measurement performance requirements, may have a significant contribution to WTRU power consumption.

In some cases, the WTRU may be configured to store some or all of the LTM candidate cell configurations even when the connection is suspended, and the WTRU is moved to RC_INACTIVE. This may enable the WTRU to perform a faster RRC reconfiguration in the case of handover. Additionally, or alternatively, this may allow LTM procedures to resume immediately or almost immediately upon resuming the RRC connection, thereby avoiding the need to perform RRC reconfiguration to set up the candidates again. Furthermore, storing the candidate cell configurations in RRC_INACTIVE may enable the use of LTM procedures, or procedures similar to LTM, during RRC state change. These procedures may be used to activate an RRC reconfiguration based on a stored configuration, to configure the SpCell (e.g. the cell on which the connection is being resumed), and/or to configure SCells. This may improve the transition from RRC_INACTIVE to RRC_CONNECTED, since limited RRC messages are needed to perform the setup (or resume), because the configuration has already been stored. The burden on WTRU processing may be limited by maintaining and determining optimal target configurations while in RRC_INACTIVE, and/or considering only the candidate configurations that are relevant for the current cell after performing a cell reselection in RRC_INACTIVE.

For a fast RRC resume, storing only the current cell's (e.g., LTM) SpCell configuration may be sufficient to provide some benefit to increase the transition speed to RRC_CONNECTED, as it is possible to apply a preconfigured RRC configuration for the SpCell (e.g., PCell) upon resuming the RRC connection. As such, signaling all or part of the configuration in the RRC Resume message may be avoided as the current cell RRC configuration is already stored. To enable faster SCG and/or SCell setup, in addition to faster PCell setup, multiple target configurations may be stored. By utilizing early measurements in combination with storing candidate cell configurations, SCells may be activated very quickly during or after RRC Connection resume without the need to perform the relatively slow RRC reconfiguration procedures to provide the complete configurations after resuming an RRC connection to the current cell (SpCell).

In some cases, the WTRU may be configured to disable and/or remove LTM candidate cells while remaining in RRC_INACTIVE state. The WTRU may dynamically disable and/or delete one or more LTM candidate configurations while remaining in RRC_INACTIVE state. In some cases, the WTRU may delete one or more LTM configurations based on satisfaction of some condition. For example, a candidate configuration may be considered valid for a given time period. In examples, the WTRU may start this time period upon transition to RRC_INACTIVE (e.g., upon reception of a suspend configuration), and may delete the configuration upon expiry of the time period. Upon completion of the time period (or some time before expiry), the WTRU may initiate a resume procedure to indicate that one or more LTM candidate configurations is about to expire.

In some cases, the WTRU may receive a message from the network indicating that one or more LTM configurations is to be deleted and/or removed while in RRC_INACTIVE. In examples, the WTRU may receive a paging message from the network indicating (e.g., within a short message) that retaining LTM candidate cells in INACTIVE is disabled, and/or that the WTRU should delete one or more (e.g., all) stored candidate configurations. In examples, the WTRU may receive the indication via an alternative DL message (e.g., RAR, MSG4, or MSGB). In examples, the WTRU may receive an indication to remove and/or delete one or more LTM candidates. The WTRU may receive the indication to remove and/or delete one or more LTM candidates, via an index pointing to a specific LTM candidate configuration.

In some cases, the WTRU may disable and/or delete one or more LTM candidate configurations based on an indication within system information. For example, the WTRU may be released from one cell (e.g., via reception of an RRC Release message) and perform cell reselection to a new cell. If the system information of the current serving cell indicates that stored LTM candidate configuration is not supported on the new cell, the WTRU may reselect another cell or may release the stored LTM candidate configurations.

In some cases, the WTRU may disable and/or delete one or more LTM candidate configurations based on a characteristic of the WTRU. For example, the WTRU may be considered “high mobility” (e.g., based on the maintained Mobility State Estimation (MSE) value) and may choose to delete one, a subset of, or all of the LTM candidate configurations. Alternatively, the WTRU may be provided with a dedicated parameter (e.g., configured within the RRC Release message), which is used to evaluate where the WTRU is in a high mobility state. In examples, this may be based on WTRU GNSS location information, WTRU sensor data, and/or a number of cell reselections performed within a time period.

In some cases, the WTRU may be configured for fast setup/resume (e.g., via early measurements and LTM trigger during random access procedure). In some cases, the WTRU may be configured to receive a pre-configuration of LTM candidate cells in RRC_CONNECTED. In some cases, the WTRU may be configured to receive a measurement configuration in RRC Release. In some cases, the WTRU may be configured to perform the measurements in RRC_INACTIVE. In some cases, the WTRU may be configured to report the measurements related to the LTM candidate cells during the random access procedure. For example, the WTRU may be configured to report the measurements in a MAC CE with Msg3 (e.g., in 4 step RA) and/or Msg A (e.g., in 2 step RA). In some cases, the WTRU may be configured to optionally perform early synchronization to a set of best candidate cells. In some cases, the WTRU may be configured to receive an indication of a candidate configuration and SCell activation and/or deactivation during the random access procedure. For example, the WTRU may be configured to receive the indication in MAC CE with Msg4 (e.g., in 4 step RA) or MsgB (e.g., in 2 step RA). In some cases, the WTRU may be configured to execute a LTM procedure upon transition to RRC_CONNECTED. For example, the WTRU may be configured to apply a stored LTM PCell configuration, with immediate SCell/SCG activation upon entering RRC_CONNECTED.

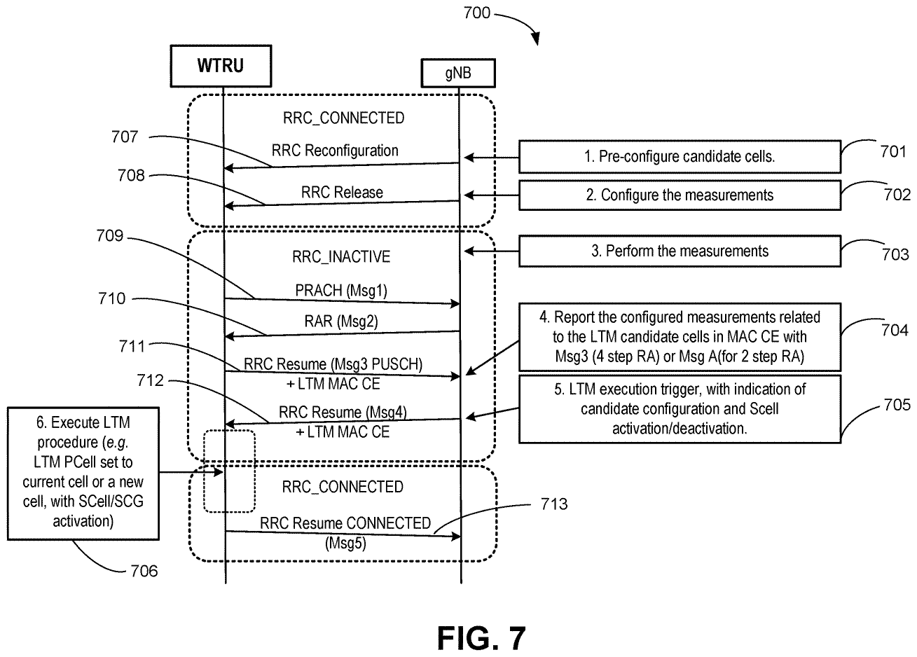

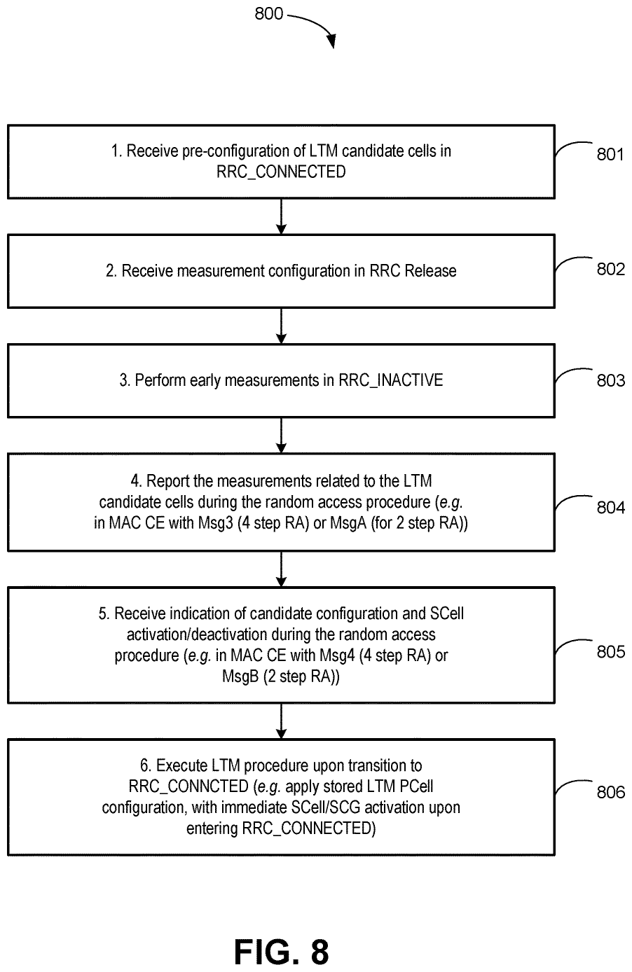

FIG. 7 and FIG. 8 illustrate example procedures and signaling for fast setup/resume at 700 and 800. At 701 and 801, the WTRU may be configured to receive a pre-configuration of LTM candidate cells in RRC_CONNECTED. At 707, the WTRU may receive configuration information. The configuration information may include an indication of one or more candidate cells (e.g., SpCells and/or SCells). For example, the WTRU may receive a configuration of one or more candidate cells using RRC Connection Reconfiguration (e.g., in candidate configuration information). The WTRU may be configured to store the candidate configurations (e.g., candidate cells) to which a handover or RRC reconfiguration may be triggered using lower layer signalling (e.g., a MAC CE).

At 702 and 802, the WTRU may be configured to receive measurement configuration in RRC Release. At 708, the WTRU receives a measurement configuration for performing early measurements. In some examples, the measurement configuration may be received in an RRC Reconfiguration message while the WTRU was in CONNECTED state. Alternatively, the measurement configuration may also be received while the WTRU is in an inactive mode. In some examples, the measurement configuration may be received separately in an RRC Release message containing a suspend configuration. In some examples, the measurement configuration may be received partially in the SIB. The measurement configuration may include a list of carriers and/or cells to perform a measurement on while in RRC_INACTIVE state. The measurement configuration may include a validity area (e.g., a list of cells or carriers on which the WTRU may be camped when the measurements shall be performed). The measurement configuration may include measurement parameters to determine how the measurements should be performed. The measurement parameters may include, for example, radio quality thresholds for including a report, one or more averaging or filtering parameters, and/or a prioritization of measurements. In some examples, the radio quality thresholds for including a report may be used to report a cell if the measurement is above an RSRP threshold. In some examples, the averaging or filtering parameters may provide an indication of how many samples to use in measurement averaging. In some examples, a prioritization of measurements may provide an indication of which cells to report if more than a maximum number of measurements can be reported.

In some cases, the RRC connection release may include one or more of a configuration of CSI-RS resource configuration, a CSI-RS reporting configuration, and beta offset parameters used for multiplexing in the PUSCH. In some cases, the RRC connection release may be used when the WTRU performs the random access procedure, such that the WTRU performs CSI-RS reporting when transmitting Msg3 and/or Msg5.

At 703 and 803, the WTRU may be configured to perform the measurements in RRC_INACTIVE. After storing Access Stratum (AS) context information upon reception of the RRC Release and moving to RRC_INACTIVE, the WTRU performs measurements according to the received configuration. In some cases, the WTRU may also store LTM candidate cell information and early measurement configurations. The WTRU may store measurement results to report later, for example, during RRC connection resume. The measurements may be associated with a validity time. In some cases, that the WTRU may report the measurements if the measurements are valid according to the validity time. For example, the WTRU may discard measurements after the validity timer expires.

At 704 and 804, the WTRU may be configured to report the configured measurements related to the LTM candidate cells in MAC CE with Msg3 711 (e.g., for 4 step RA) or Msg A (e.g., for 2 step RA), or via small data transmission. The WTRU may be configured to report the stored measurements from 703 during the random access procedure. At 709, the WTRU may indicate by selecting one from a configured set of random access preambles or resources that measurements are available. At 710, the gNB may provide an uplink grant in a random access response (RAR) providing a large enough grant to include some or all of the measured results. In some cases, the amount of data granted in the RAR determines whether, and how many, measured results may be included in the uplink message 711. In some cases, if the initial grant is too small, the WTRU may send results over multiple transmissions. For example, if the initial grant is too small, the WTRU may send results over multiple transmissions via small data transmission methods (e.g., dynamic grant for subsequent transmission and/or configured grants). In some cases, the WTRU may be preconfigured with an uplink grant in order to transmit measured results in MsgA. According to the amount of data available that is provided in the uplink grant received in RAR, the WTRU may determine which results to send. For example, the WTRU may determine that the best N measurements of neighbor cells may be reported. In some cases, the WTRU may include measured results up to the maximum allowable by the received uplink grant in RAR.

In some cases, the PDCCH scheduling Msg2 710, the RAR, may contain an indication (e.g., a 1-bit field) which may be referred to as “request LTM measurement”. The WTRU may use the indication to determine whether to send measurement results. For example, if the field is “1”, the WTRU may determine and send the measurements in Msg3 711 (e.g., in a MAC CE within Msg3 711). In some examples, if the field is “0”, the WTRU may determine not to send the measurements (if any). In some cases, the “request LTM measurement” indication may be in the RAR 711.

In some cases, the measured results may be included in a MAC CE transmitted with Msg3 711 or MsgA. In some cases, the measured results are included in Msg5 713 (e.g., RRC Resume Complete) or in an RRC message following the connection resume (e.g., WTRU information response), either in an RRC message or in a MAC CE.

In some cases, the WTRU may be configured to provide the measurements using CSI reporting (e.g., using UCI). The WTRU may be configured to transmit the measurements with Msg3 711 or with Msg5 713 using parameters that have been either preconfigured as part of LTM candidate configuration in RRC reconfiguration, as part of the early measurement configuration in RRC Release, or broadcast in the broadcast system information. In some cases, the PDCCH scheduling Msg2 or Msg2 710 may include a pointer (e.g., a bitfield) to a PUCCH resource. The WTRU may use the pointer to send the measurements. In cases in which one or more PUCCH resources are configured (e.g., at 701 and/or 702) the WTRU may use the pointer to select one of the resources. In some cases, reception of the PDCCH scheduling Msg2 710 and/or Msg2 710 may trigger the WTRU to transmit PUCCH, in which the measurements may be within the PUCCH.

In some cases, the MAC CE sent by the WTRU may include a flag/indicator. The flag/indicator may indicate that the conditions of the one or more LTM candidate cells (e.g., SpCell and SCell(s)) are the same or similar (e.g., within a threshold delta RSRP) to the conditions when the WTRU was suspended. For example, the flag/indicator may indicate to the network that the WTRU can be resumed with the same cell group configuration as before.

In some cases, the MAC CE sent by the WTRU may be based on an event configured for the WTRU while in CONNECTED state, or within the RRC Release message. For example, the WTRU may include the cell indexes within the LTM candidate set list that fulfill a certain radio signal level condition. The event may correspond to the WTRU including the cell indexes within the LTM candidate set list that are above a certain configured RSRP threshold.

In some cases, the WTRU may send the MAC CE that includes measurement related information for the LTM candidate cells. In some cases, the WTRU may send the detailed L3 measurement report. The detailed L3 measurement report may include information about cells that may be outside the LTM candidate list (e.g., in the RRC Resume Complete message).

In some cases, the WTRU may determine one or more of the following: whether to include a MAC CE containing measurement results in msg3 711 (e.g., or msgA); whether to include a MAC CE containing measurement results in msg5 713; whether to multiplex the results as CSI in PUSCH msg3 711 or msgA; a number of cells or SSB index for which measurements are reported; an indication of applicable CSI reporting configuration or aperiodic CSI trigger state; a set of SSB indices or CSI-RS resources for which the measurements are provided; as a function of size of the msg3 711 or msgA grant; a property of the grant for msg3 711 such as frequency allocation; an indication from random access response grant or from DCI addressed to TC-RNTI; and/or an SSB index associated to the random access occasion used for transmission of PRACH. In examples, for the cases in which the WTRU determines a function of size of the msg3 711 or msgA grant the WTRU may include measurement results if the size of such grant is above a threshold pre-defined or configured. In examples, for the cases in which the WTRU determines the indication from random access response grant or from DCI addressed to TC-RNTI, the indication may be determined from an existing field. The existing field may comprise one or more of a time domain resource allocation (TDRA), a modulation and coding scheme (MCS), and/or a transmit power control (TPC). In examples, for the cases in which the WTRU determines the SSB index, the WTRU may report CSI measurements or measurements by MAC for this SSB index. In examples, for the cases in which the WTRU determines the SSB index, the WTRU may determine the set of CSI-RS resources for the CSI measurement as the resources that are quasi-co-located with the SSB index.

In some cases, the configuration for multiplexing CSI reports in msg3 711 or msgA PUSCH may include one or more of the following: multiplexing information (e.g., beta offsets and maximum code rate); one or more CSI report configuration; one or more aperiodic CSI trigger state; one or more resource set for channel measurements (e.g., SSB or CSI-RS resource set); one or more resource set for interference measurements (e.g., non-zero-power CSI-RS or CSI for interference measurement (CSI-IM).

In some cases, the WTRU may be indicated to determine the timing advance towards a candidate cell. The WTRU may determine the timing advance by transmitting a random-access preamble to the candidate cell. The WTRU may receive a PDCCH order while the WTRU is in INACTIVE state. The order may include PCI of one or more of the candidate cells, SSB or CSI-RS associated to the PCI, a preamble index, etc. The timing advance towards the candidate cell may be received from the serving cell in PDSCH.

In some cases, the WTRU may transmit the same preamble the WTRU used in Msg1 709 towards the candidate cell and may not be indicated a preamble index. The WTRU may determine the random-access occasion from the SSB and/or CSI-RS reported or prepared to be reported as part of the LTM measurements. The WTRU may also use the same PRACH mask index the WTRU may have used for PRACH transmission in Msg1. In some cases, the PDCCH scheduling Msg2 710 or Msg2 710 may include an order for the WTRU to send the preamble, for example, towards a candidate cell. The order may be a 1-bit indication. The WTRU may reuse one or more of the RACH parameters used in Msg1 709.

At 705 and 805, the WTRU may be configured to receive LTM execution trigger, with an indication of candidate configuration and SCell activation and/or deactivation (e.g., and/or other candidate configuration information). In some solutions, the WTRU may receive the LTM execution trigger in a MAC CE sent with Msg4 712 (e.g., RRC Resume). In some cases, the WTRU may be configured to receive an LTM execution trigger in a separate DL transmission than Msg4 712. For example, the WTRU may be configured to receive an LTM execution trigger in a separate DL transmission than Msg4 712 for before or after Msg4 712, or after Msg5 713. In some cases, the LTM trigger may include an index to the SpCell. In some cases, the SpCell may be the cell on which the random access procedure was initiated. In some cases, the LTM execution may include an indication of the SCells to activate.

At 706 and 806, the WTRU may be configured to execute anLTM procedure (e.g., LTM PCell set to current cell or a new cell, with SCell/SCG activation). The WTRU may apply the stored configuration(s) according to the indication(s) received in the LTM trigger. This may include a SpCell and/or SCell(s). In some cases, if the LTM trigger may be received before or at the same time as Msg4 712, the WTRU may be apply the configurations prior to sending Msg5. In some cases, if the RRC State may be changed to RRC_CONNECTED. The WTRU may be configured to transmit the RRC Resume Complete (Msg5) using the applied (stored) configuration indicated at 705 and 805.

In some cases, the WTRU may be configured for a LTM candidate update in RRC_INACTIVE. In some cases, the WTRU may be configured to receive a configuration (e.g., configuration information) of LTM candidate cells from a first cell. In some cases, the WTRU may be configured to determine a first set of LTM candidate cells from the received configuration, based on a validity condition associated with the first cell. In some cases, the WTRU may be configured to perform LTM using the first set of candidate cells. In some cases, the WTRU may be configured to receive an RRC release and suspend the RRC connection. In some cases, the WTRU may be configured to reselect a second cell and determine a second set of LTM candidate cells from the received configurations. In some cases, the WTRU may be configured to reselect a second cell and determine a second set of LTM candidate cells from the received configurations, based on a validity condition (e.g., a list of valid cell IDs, a RSRP threshold, etc.) associated with the second cell. In some cases, the WTRU may be configured to resume the RRC Connection on the second cell. In some cases, the WTRU may be configured to perform LTM using the second set of candidate cells.

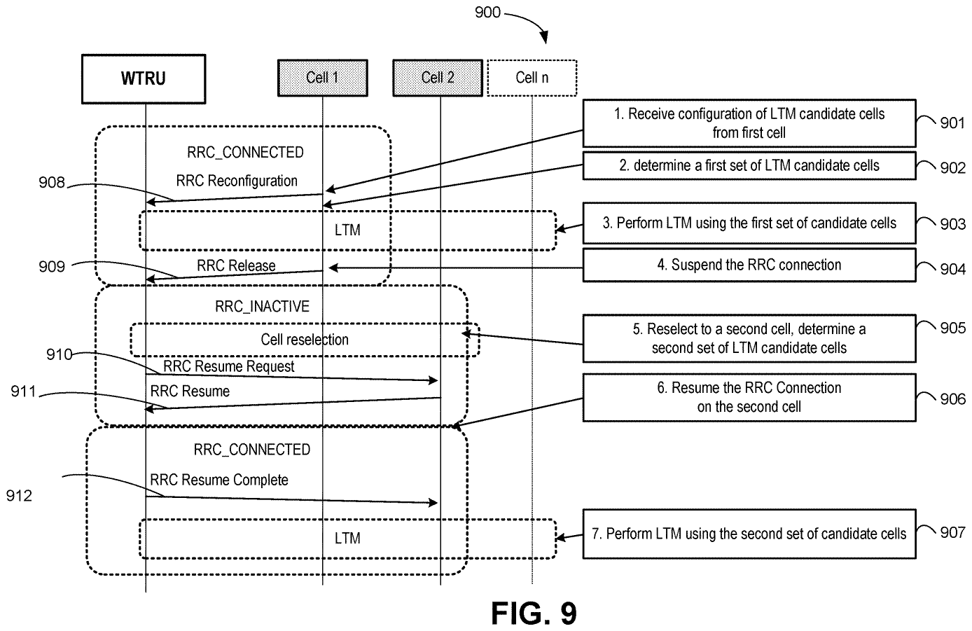

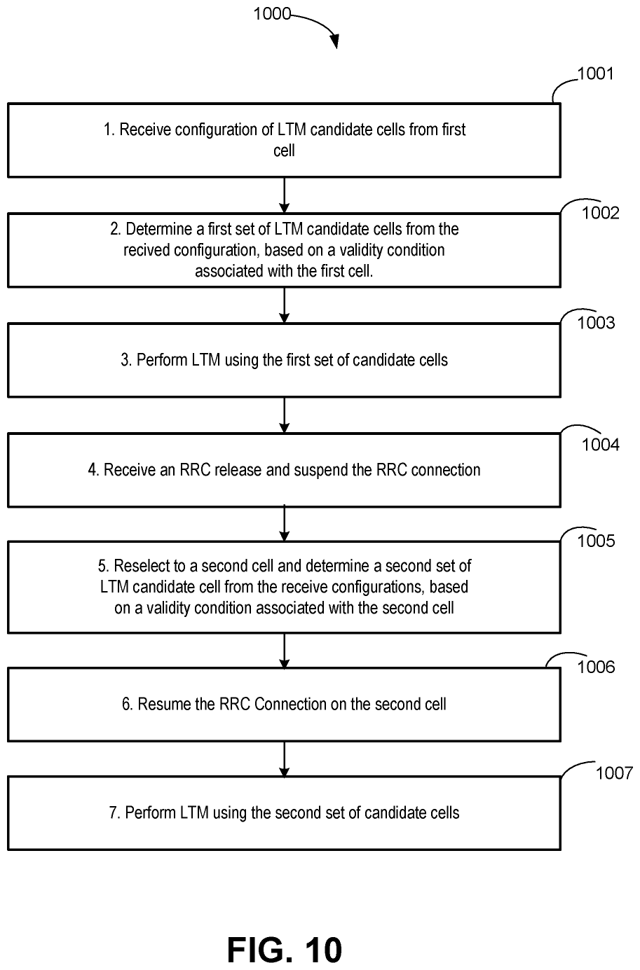

FIG. 9 and FIG. 10 illustrate example procedures and signaling for LTM candidate maintenance in RRC_INACTIVE at 900 and 1000. At 901 and 1001, the WTRU may be configured to receive configuration information indicating LTM candidate cells from a first cell. The WTRU may receive a configuration of one or more candidate SpCells and/or SCells. For example, the WTRU may receive the configuration information indicating one or more candidate SpCells and/or SCells using RRC Connection Reconfiguration 908. The WTRU may receive a configuration of one or more candidate SpCells and/or SCells using RRC Connection Reconfiguration 908. The WTRU may store the candidate configurations to which a handover or RRC reconfiguration may be triggered using lower layer signalling (e.g., a MAC CE). The WTRU may receive a configuration providing an association between a particular serving (or camped on) cells and the candidate configurations valid on the serving (or camped on) cell prior to release to RRC_INACTIVE (e.g., the candidate configurations valid in each potential selected suitable cell).

At 902 and 1002, the WTRU may be configured to determine a first set of LTM candidate cells. The WTRU may determine a subset of LTM candidate cells from the configured set, which are valid in the current serving cell. The WTRU may determine which cells are valid based on a configuration received at 901 or 1001.

At 903 and 1003, the WTRU may be configured to perform LTM using the first set of candidate cells. Using the first set of candidate cells, the WTRU may perform LTM. The WTRU may perform a cell switch amongst cells in the first set of candidate cells. In some cases, the WTRU may perform a cell switch amongst cells in the first set of candidate cells, upon receiving one or more MAC CE indicating a SpCell change and/or SCell activation or deactivation.

At 904 and 1004, the WTRU may be configured to suspend the RRC connection. Upon receiving RRC Release 909 with a suspend configuration, the WTRU may move to RRC_INACTIVE and keep the stored LTM candidate configurations configured at 901 (or 1001). The WTRU may receive an indication in the RRC release 909, or as part of the pre-configurations received at 901 or 1001, which of the candidate configurations to maintain or to release. For example, the RRC Release message 909 may include an indication to store a first candidate cell configuration and to release a second candidate cell configuration. Additionally, or alternatively, as part of the candidate cell (pre)configuration at 901 (or 1001), the WTRU may receive an indication for each candidate configuration in which cells (e.g., SpCells) in the candidate is valid. Upon reception of the RRC Release message 909, the WTRU may determine that for the current SpCell a candidate cell configuration can be released. The current SpCell may be the cell on which RRC Release 909 is received.

At 905 and 1005, the WTRU may be configured to select a second cell or reselect to a second cell. In RRC_INACTIVE, the WTRU may perform cell reselection measurements and evaluation. The WTRU may determine that a new (e.g., a second) cell is more suitable than the current (e.g., a first) cell and perform cell reselection to the second cell. When the WTRU performs cell reselection, the WTRU may acquire system information of the second cell. Further, the WTRU may receive a list of neighbor carriers and/or cells. From the list of neighbor carriers and/or cells, the WTRU may determine and update the valid (e.g., in use) candidate set. For example, the WTRU may use a first LTM candidate set while camped on a first cell and use a second LTM candidate set after performing reselection to a second cell (e.g., cell 1: set1, cell2: set2). This determination may be based on a validity condition. For example, this determination may be based on determining which candidate cell configurations received at 901 or 1001 are also broadcast in the new/second cell system information as neighboring cells. In some cases, an LTM specific information element (IE) may be broadcast, indicating which cells can be considered as valid LTM neighbor cells. In some cases, the broadcast information may include some specific parameters to be applied, including but not limited to, measurement report trigger thresholds, and/or cell associations (e.g., associations in which cells belong to the same or a different group for reporting). In some cases, the WTRU may review the existing idle mode neighbor list to determine the neighbor cells. If the candidate cell appears in the neighbor list, the WTRU may determine that the candidate cell is valid in the second cell. If the candidate cell does not appear in the neighbor list, the WTRU may determine that the candidate cell is not valid in the second cell.

In some cases, the WTRU may receive an indication as part of the candidate cell configuration at 901 or 1001. The indication may specify the cells (e.g., camped on cells or SpCells) of the one or more candidate cell configurations are valid. Based on the preconfigured information, the WTRU may determine, during or after a cell reselection, which candidate cells are valid in the new cell.

In some cases, the WTRU may prioritize cell re-selection to cells within the current LTM candidate set. For example, the WTRU may be configured to add a certain offset to the measurements of the cells that belong to the LTM candidate list when performing cell re-selection based cell rankings and/or comparisons. The WTRU may be configured with separate cell reselection priorities for cells that belong to the LTM candidate list. The WTRU may be configured with an offset to apply to the cell reselection priority for cells that belong to the LTM candidate set.

In some cases, the WTRU, after performing a cell re-selection, may determine the LTM candidate set to use based on which candidate cell list the WTRU is camping on the current cell (e.g., target cell of the cell reselection).

In some cases, if the WTRU makes a cell re-selection to a cell that belongs to the current LTM candidate set, the WTRU may maintain the current candidate set.

In some cases, if the WTRU, after performing a cell re-selection, determines that there are multiple LTM candidate sets that correspond to the selected cell, the WTRU may determine the LTM candidate set to use based on a number of neighbor cells that the WTRU can measure that belong to the LTM candidate set. For example, the WTRU may determine the LTM candidate set to use based on a number of neighbor cells that the WTRU can measure with a signal level at least better than a certain configured threshold. Further, the WTRU may determine the LTM candidate set to use by selecting the LTM candidate set that has the current camping cell and the most neighbor cells the WTRU has detected at a good level.

At 906 and 1006, the WTRU may be configured to resume the RRC Connection on the second cell. When resuming the RRC connection on the second cell, the WTRU may enable LTM using the set of LTM candidates determined at 905 or 1005. In some cases, the new set of candidate cells may be assigned new candidate cell indexes. In some cases, the WTRU may be configured to assign the new set of candidate cells new candidate cell indexes (e.g., from 0 to 31). In some cases, the WTRU may be configured to assign the new set of candidate cells new candidate cell indexes in the order in which they were received in the configuration at 901 or 1001.

At 907 and 1007, the WTRU may be configured to perform LTM using the second set of candidate cells. The WTRU may perform LTM procedures as described herein. For example, the WTRU may perform LTM procedures by performing one or more (e.g., all) of the steps described in FIG. 5. The WTRU may perform LTM procedures by one or more of performing early synchronization in DL and/or UL to one or more of the candidate cells, performing L1 measurements and reporting on one or more of the candidate cells, and/or switching (e.g., performing handover) between candidate cells.

In some cases, the WTRU may be configured for a validity area RAU update. In some examples, the WTRU may determine after a cell reselection that the cell does not correspond to any of the LTM candidate cells. For example, the WTRU may determine that no SpCell configuration is stored for the cell or no valid target cell candidates are stored for the cell. In such cases, the WTRU may initiate an RRC Resume to inform the network that the cell is outside of the LTM validity area. In some cases, the LTM validity area may be a list of carriers or cells. In some cases, the LTM validity area may be a specific one or more RAN notification areas (RNA). If the newly selected cell does not belong to the validity area, the WTRU may initiate an RRC Resume. The RRC Resume may indicate a new cause value (e.g., out of LTM validity area). The WTRU may send an uplink indication following RRC Resume, for example, in a WTRU Assistance information message. The WTRU may release some or all of the configured LTM candidate configurations. Following the indication, the WTRU may receive a new LTM candidate set and a new validity area. The connection may be suspended again.

In some cases, upon determining that the WTRU is outside the LTM validity area, the WTRU may not trigger the Resume procedure to update the network that the WTRU is outside the LTM validity area. Rather, the WTRU may release the LTM configuration and continue operating as in legacy INACTIVE state. Upon connection resumption, the WTRU may send an indication (e.g., in a new cause value in the resume message, using a certain configured RACH preamble, using a MAC CE multiplexed with the resume message, etc.) that the LTM configuration has been released.

In some cases, upon determining that the WTRU is outside the LTM validity area, the WTRU may not trigger the Resume procedure to update the network that the WTRU is outside the LTM validity area. The WTRU may keep the LTM configuration but consider the LTM configuration inactive or not enabled (e.g., not perform any LTM related actions that the WTRU was configured to perform while in the INACTIVE state). The WTU may continue operating as in legacy INACTIVE state. If the WTRU re-selects back to a cell that belongs to an LTM candidate set, the WTRU may consider that the LTM candidate set is now active and starts performing any LTM related actions that the WTRU is configured to perform while in INACTIVE state.

In some cases, the WTRU may be configured for LTM early measurement maintenance in RRC_INACTIVE. In some cases, the WTRU may be configured to receive configuration information (e.g., via RRC reconfiguration) of pre-configured LTM candidate cells from a first cell. In some cases, the WTRU may be configured to receive an indication (e.g., via RRC release) to enable measurements for pre-configured LTM candidate cells in RRC_INACTIVE. In some cases, the WTRU may be configured to reselect to a second cell. In some cases, the WTRU may be configured to receive cell specific information (e.g., current neighbors) from a second cell. In some cases, the WTRU may be configured to determine a subset of cells based on the pre-configured LTM candidate cells and the cell-specific information from the second cell and perform radio quality measurements on the subset of cells. The WTRU may send an RRC Resume Request message 910 to the gNB and may receive in response an RRC Resume message 911. In some cases, the WTRU may be configured to resume the RRC Connection on the second cell and report the radio quality measurements corresponding to the subset of cells to the second cell (e.g., in an RRC Resume Complete message 912).

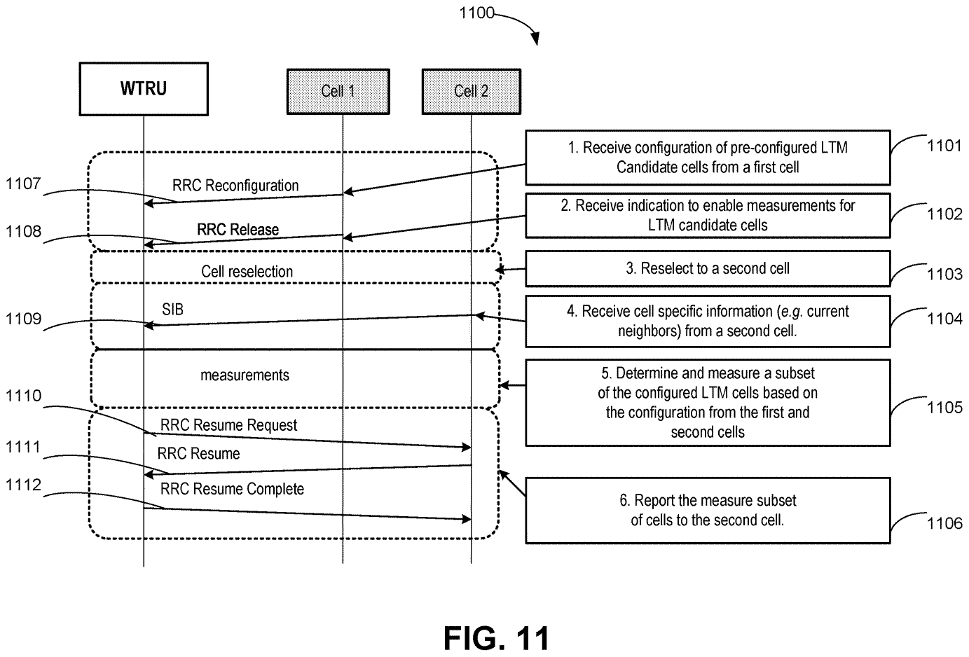

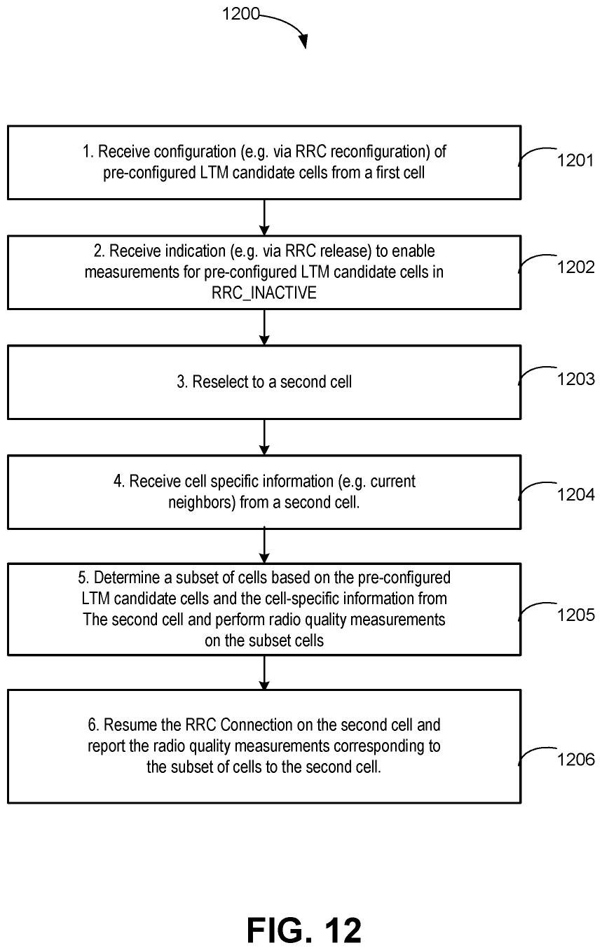

FIG. 11 and FIG. 12 illustrate example procedures and signaling for LTM early measurement maintenance in RRC_INACTIVE. At 1101 and 1201, the WTRU may be configured to receive pre-configuration of LTM candidate cells in RRC_CONNECTED. The WTRU may receive a configuration of one or more candidate cells (e.g., SpCells and/or SCells). For example, the WTRU may receive a configuration of one or more candidate cells using RRC Connection Reconfiguration 1107. The WTRU stores the candidate configurations (e.g., Candidate cells) in which a handover or RRC reconfiguration may be triggered using lower layer signalling (e.g., a MAC CE).

At 1102 and 1202, the WTRU may be configured to receive measurement configuration for LTM cells in RRC Release 1108. The WTRU may receive a measurement configuration for performing early measurements. In particular, the WTRU may receive measurement configuration for performing early measurements on LTM candidate cells. In some cases, the measurement configuration may be received in the RRC Reconfiguration message 1107. In other cases, the measurement configuration may be received separately in an RRC Release message 1108 containing a suspend configuration. The measurement configuration may include a list of carriers and/or cells on which to perform measurements while in RRC_INACTIVE state. The measurement configuration may additionally include a validity area. For example, the validity area may be a list of cells or carriers on which the WTRU may be camped when the measurements are performed. The measurement configuration may additionally include measurement parameters to determine how the WTRU performs the measurements. The measurement parameters may include, for example, but are not limited to, one or more of radio quality thresholds for including a report, an averaging or filtering parameters, and/or prioritization of measurements. The WTRU may determine to report the measurements based on radio quality thresholds for including the measurements in the report (e.g., the WTRU may report a cell if the measurement is above an RSRP threshold). The WTRU may determine to perform the measurements based on averaging or filtering parameters that include an indication of how many samples to use in measurement averaging. The WTRU may determine to report the measurements based on the prioritization of measurements of cells to report if more than a maximum number of measurements may be reported.

In some cases, the measurement configuration may indicate that the WTRU should perform measurements of all LTM candidate cells. In other cases, the measurement configuration may indicate that the WTRU should perform measurements on a subset of LTM candidate cells. The measurement configuration may include a configuration to measure cells outside of the LTM candidate set. In some cases, the measurement configuration may include one or more of a relative priority for measurements, a reporting of different sets of LTM, and/or non-LTM candidate cells.

At 1103 and 1203, the WTRU may be configured to reselect to a second cell. In RRC_INACTIVE, the WTRU may perform cell reselection measurements and evaluation. In some cases, the WTRU may determine that a new (e.g., a second) cell is more suitable than the current (e.g., a first) cell and perform cell reselection to the second cell.

At 1104 and 1204, the WTRU may be configured to receive cell specific information (e.g., current neighbors) from a second cell. When the WTRU performs cell reselection, the WTRU may acquire system information of the second cell. The WTRU may receive a list of neighbor carriers and/or cells. In some cases, the neighbor list may be the existing idle mode neighbor cells. In some cases, the neighbor list may be a separate list for determining early measurement neighbors.

At 1105 and 1205, the WTRU may be configured to determine and measure a subset of the LTM cells based on the configuration from the first and second cells. In some cases, the WTRU may determine and update the valid (e.g., in use) early measurements from the list of neighbor carriers and/or cells. For example, the WTRU may use a first set of early measurement candidates while camped on a first cell and a second set of early measurement candidates after performing reselection to a second cell (e.g., cell 1: measurement set1, cell2: measurement set2). The determination may be based on checking which measurement configurations received at 1101 or 1201 are also broadcast in the new/second cell system information as neighboring cells. In some cases, if the cell configured for early measurement appears in the neighbor list, the WTRU may be considered valid in the second cell. In some cases, if the cell configured for early measurement does not appear in the neighbor list, the WTRU may be considered not valid in the second cell.

Upon determining the cells configured for which early measurements are valid in the new cell, the WTRU may perform measurements on those cells according to the relevant measurement requirements. In some cases, the set of requirements valid for LTM candidate cells may be different than those for non-LTM cells. In examples, the set of requirements valid for LTM candidate cells may have a higher sampling rate, shorter filtering, and/or a shorter timescale. In some cases, the WTRU may perform a different type of measurement for LTM candidate cells and non-LTM candidate cells. In examples, the WTRU may perform L1 beam RSRP measurements on LTM candidate cells. In examples, the WTRU performs L3 (e.g., L3 filtered) measurements or cell level RSRP measurements on non-LTM candidate cells. The cell level RSRP measurements may be, for example, an averaged RSRP amongst multiple beams. The WTRU may additionally or alternatively be configured to perform different measurement types on different LTM candidate cells. For example, cells belonging to the same DU as the current cell may be configured with one type of measurement, while cells belonging to another DU than the current cell may be configured with another type of measurement. The specific cells for which a particular measurement type applies may depend on a configured relationship between that cell and the current cell. For example, LTM and/or non-LTM cells may be configured as groups. If the current and measured cell belongs to the same group, one type of measurement may apply. Otherwise, a different type of measurement may apply. The measurement may depend on the frequency band of the neighbor cell. For example, FR2 carriers may use one set of measurement requirements, and FR1 carriers may use another set of measurement requirements. In some cases, limits may be configured for measurements (e.g., to maximize the number of cells or carriers measured, or maximize the number of cells or carriers from a particular group measured).

In some cases, if the WTRU is configured with LTM and sent to the INACTIVE state, the WTRU may continue to perform the early measurement for the whole duration of the INACTIVE state. That is, the WTRU may perform the early measurement until the WTRU transitions to CONNECTED state. As such, the WTRU may disregard any measIdleDuration configuration that is associated with early measurements. Alternatively, the WTRU may be explicitly configured with a very long measIdleDuration (e.g., a duration infinity) to effectively disable the time duration limitation.

In some cases, the WTRU may stop early measurements for a given cell configured for early measurement if the cell does not belong to the saved LTM candidate set according to the legacy measIdleDuration The WTRU may stop early measurements for the given cell while the WTRU may continue early measurements for a given cell configured for early measurement if the cell belongs to the saved LTM candidate set even after the measIdleDuration has elapsed.

At 1106 and 1206, the WTRU may be configured to report the measured subset of cells to the second cell. The WTRU may report the stored measurements of the subset of cells to the second cell. In some cases, the report may be transmitted, for example, as a MAC CE with Msg3, Msg5, or another uplink RRC Message. In some cases, this report may be an RRC message, or an extension of an RRC message, including but not limited to, an RRC Resume Request 1110, RRC Resume Complete 1112, and/or WTRU information response. In examples, in case the WTRU measures LTM and non-LTM candidate cells while in RRC_INACTIVE, and the uplink grant provided for sending a Msg3 or a Msg5 including measurement results is not sufficient to include all of the results, the WTRU may prioritize including the LTM candidate cell measurements over non-LTM cell measurements. In examples, a limit may be configured in the reporting configuration specifying the maximum number of measurement results to include. The limit may be configured to report the configuration as part of step 2. In examples, multiple limits may be specified, for example, to include X cells belonging to one group and Y cells belonging to another group in the report. As such, the specified multiple limits may be used by the gNB to determine, for example, whether to set up one or another CSG based on the SCell measurements for each group.

In some cases, the WTRU may be configured for a validity area RAU update. In some examples, the WTRU may determine after a cell reselection that the cell does not correspond to any of the LTM candidate cells. In examples, the WTRU may determine that no SpCell configuration is stored for the cell and/or no valid target cell candidates are stored for the cell. In examples, the WTRU may determine that the WTRU is outside of the set of configured early measurements. For example, the WTRU may determine that the WTRU is outside of the early measurements validity area. In such cases, the WTRU may initiate an RRC Resume to inform the network that the WTRU is outside of the LTM early measurements validity area. In some cases, the LTM validity area may be a list of carriers or cells. In one or more other cases, the LTM validity area may be a specific to one or more RAN notification areas (RNA). If the newly selected cell does not belong to the validity area, the WTRU may initiate an RRC Resume. In some cases, the RRC Resume may indicate a new cause value (e.g., out of LTM validity area). In other cases, the WTRU may send an uplink indication following RRC Resume, for example in a UE/WTRU Assistance information message. In some cases, the WTRU may release some or all of the configured LTM candidate configurations. Following the indication, the WTRU may receive a new LTM candidate set and a new validity area. In such cases, the connection may be suspended again.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed is:

1. A wireless transmit/receive unit (WTRU) comprising:
a processor configured to:
receive configuration information from a first cell while the WTRU is in a connected mode, wherein the configuration information indicates a plurality of L1/L2-triggered mobility (LTM) candidate cells;
receive a measurement configuration while the WTRU is in an inactive mode;
perform measurements on one or more cells of the plurality of LTM candidate cells while the WTRU is in the inactive mode in accordance with the measurement configuration;
send a report comprising the measurements related to the one or more cells of the plurality of LTM candidate cells during a random access procedure;
receive candidate configuration information for at least one LTM candidate cell of the plurality of LTM candidate cells during the random access procedure; and
execute an LTM procedure for the at least one LTM candidate cell upon the WTRU transitioning to the connected mode.

2. The WTRU of claim 1, wherein the processor is configured to receive the measurement configuration via a radio resource control (RRC) release message while the WTRU is in the inactive mode.

3. The WTRU of claim 1, wherein the processor is configured to receive the candidate configuration information via a medium access control (MAC) control element (CE).

4. The WTRU of claim 1, wherein the processor is configured to perform early synchronization to the at least one LTM candidate cell prior to receiving the candidate configuration information.

5. The WTRU of claim 1, wherein the processor is configured to apply the candidate configuration information for the at least one LTM candidate cell to execute the LTM procedure for the at least one LTM candidate cell upon the WTRU transitioning to the connected mode.

6. The WTRU of claim 1, wherein the measurements performed on the one or more cells of the plurality of LTM candidate cells comprise reference signal received power (RSRP) measurements for the one or more cells of the plurality of LTM candidate cells.

7. The WTRU of claim 1, wherein the processor is configured to send the report comprising the measurements related to the one or more cells of the plurality of LTM candidate cells via a medium access control (MAC) control element (CE).

8. The WTRU of claim 1, wherein the configuration information comprises parameters, and the processor is configured to:
select one or more LTM candidate cells from the plurality of LTM candidate cells based on the parameters, wherein the report comprises an indication of the one or more selected LTM candidate cells.

9. The WTRU of claim 8, wherein the parameters comprise a reference signal received power (RSRP) threshold, or a reference signal received quality (RSRQ) threshold.

10. The WTRU of claim 1, wherein, to execute the LTM procedure for the at least one LTM candidate cell upon the WTRU transitioning to the connected mode, the processor is configured to:
apply configuration information for a primary cell associated with the at least one LTM candidate cell and activate one or more secondary cells.

11. A method to be performed by a wireless transmit/receive unit (WTRU), the method comprising:
receiving configuration information from a first cell while the WTRU is in a connected mode, wherein the configuration information indicates a plurality of L1/L2-triggered mobility (LTM) candidate cells;
receiving a measurement configuration while the WTRU is in an inactive mode;
performing measurements on one or more cells of the plurality of LTM candidate cells while the WTRU is in the inactive mode in accordance with the measurement configuration;
sending a report comprising the measurements related to the one or more cells of the plurality of LTM candidate cells during a random access procedure;
receiving candidate configuration information for at least one LTM candidate cell of the plurality of LTM candidate cells during the random access procedure; and
executing an LTM procedure for the at least one LTM candidate cell when the WTRU transitions to the connected mode.

12. The method of claim 11, wherein the measurement configuration is received via a radio resource control (RRC) release message while the WTRU is in the inactive mode.

13. The method of claim 11, wherein the candidate configuration information is received via a medium access control (MAC) control element (CE).

14. The method of claim 11, further comprising performing early synchronization to the at least one LTM candidate cell prior to receiving the candidate configuration information.

15. The method of claim 11, further comprising applying the candidate configuration information for the at least one LTM candidate cell to execute the LTM procedure for the at least one LTM candidate cell when the WTRU transitions to enters the connected mode.

16. The method of claim 11, wherein the measurements performed on the one or more cells of the plurality of LTM candidate cells comprise reference signal received power (RSRP) measurements for the one or more cells of the plurality of LTM candidate cells.

17. The method of claim 11, wherein the report comprising the measurements related to the one or more cells of the plurality of LTM candidate cells is sent via a medium access control (MAC) control element (CE).

18. The method of claim 11, wherein the configuration information comprises parameters, further comprising:
selecting one or more LTM candidate cells from the plurality of LTM candidate cells based on the parameters, wherein the report comprises an indication of the one or more selected LTM candidate cells.

19. The method of claim 18, wherein the parameters comprise a reference signal received power (RSRP) threshold, or a reference signal received quality (RSRQ) threshold.

20. The method of claim 11, wherein, executing the LTM procedure for the at least one LTM candidate cell when the WTRU transitions to the connected mode comprises:
applying configuration information for a primary cell associated with the at least one LTM candidate cell and activating one or more secondary cells.
